(19) United States
(12) Patent Application Publication
(10) Pub. No.: US 2008/0184078 A1
(43) Pub. Date: Jul. 31, 2008

(54) MANIPULATING A CONFIGURATION FILE FOR A NETWORK SWITCH

(75) Inventors: Guy Herriott, Placerville, CA (US); John Presley Thornton, Fair Oaks, CA (US); David L. Santos, Granite Bay, CA (US); John R. Reilly, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/669,892

(22) Filed: Jan. 31, 2007

(51) Int. Cl. G06F 15/177; G06F 11/07

(52) U.S. Cl. 714/48; 709/221; 714/E11.025

(57) ABSTRACT

A method of manipulating a configuration file for a network switch is described. The method comprises generating a difference list based on a comparison of an existing configuration file and a new configuration file for a network switch. The method further comprises executing commands from the generated difference list to configure the network switch and generating a revised configuration file based on the new configuration file and the existing configuration file.

### BACKGROUND

Typically, a network switch configuration is set and maintained using a command line interface (CLI). Configuration changes to the network switch are often time-consuming and error-prone due to the degree of human involvement by virtue of use of the CLI.

Another method of configuring a network switch comprises use of a configuration file to set and maintain the switch configuration. A user creates a configuration file comprising a plurality of configuration commands for execution by the network switch.

### DESCRIPTION OF THE DRAWINGS

One or more embodiments of the present invention are illustrated by way of example, and not by limitation, in the figures of the accompanying drawings, wherein elements having the same reference numeral designations represent like elements throughout and wherein:

FIG. 1 is a high-level functional block diagram of a network usable in conjunction with an embodiment according to the present invention;

FIG. 2 is a high-level process flow diagram of an embodiment according to the present invention; and

FIG. 3 is a detail view of a portion of FIG. 1 according to another embodiment.

### DETAILED DESCRIPTION

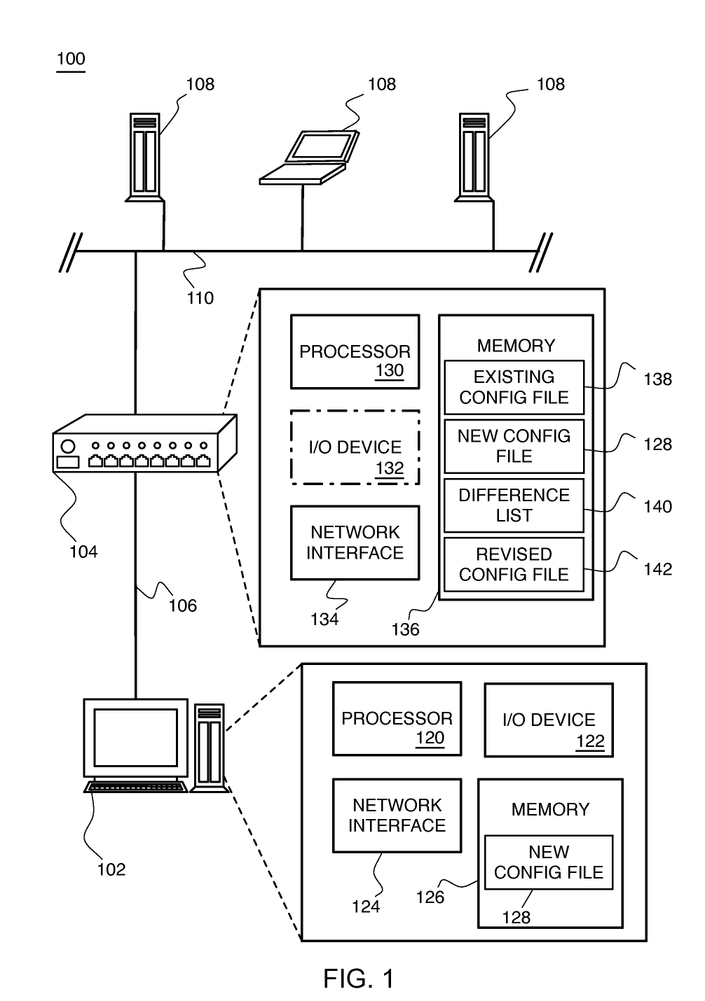

FIG. 1 depicts a high-level functional block diagram of a network 100 in conjunction with which an embodiment of the present invention may be used to great advantage. Network 100 comprises a user computer system 102, e.g., a processing device, communicatively coupled with a network switch 104 via a switch connection 106. Network switch 104, in turn, communicatively couples additional computing devices 108 to each other and computer system 102 via network link 110. Network switch 104 receives and transmits signals over network link 110 and switch connection 106 enabling communication between and among computing devices 108 and/or user computer system 102.

User computer system 102 comprises a processor 120, an input/output (I/O) device 122, a network interface 124, and a memory 126 communicatively coupled to each other and/or via a bus-based mechanism. Processor 120 controls operation of user computer system 102 according to instructions and/or input received from one or more of I/O device 122, network interface 124, and instructions stored in memory 126.

Input/output device 122 transmits user-supplied commands and information to computer system 102 and/or displays information from processor 120 to a user. For example, I/O device 122 may comprise input devices such as a keyboard, a touch-screen display, a mouse, and a voice recognition system, etc. and the I/O device may comprise output devices such as an audio speaker, a haptic feedback mechanism, or another device capable of communicating information to the user.

Network interface 124 communicatively couples computer system 102 to network switch 104 via switch connection 106. In at least some embodiments, network interface 124 provides for one-way and/or two-way network communication with network switch 104. Network interface 124 sends and receives electrical, electromagnetic, and/or optical signals which carry digital data streams representing various types of information. Network interface 124 may comprise wired and/or wireless links.

Memory 126, such as a magnetic-based memory, an electronic-based memory, or an optical-based memory, is provided and coupled with computer system 102 for storing data and instructions. In at least one embodiment, memory 126 stores a new configuration file 128 comprising one or more commands for execution by network switch 104. Commands for execution by network switch 104 comprise commands to modify the configuration of the network switch, e.g., hostname “HP ProCurve Switch 5308XL”, snmp-server community “public, no vlan 20, etc.

In operation, a user of computer system 102 manipulates the computer system to create new configuration file 128, e.g., by use of an editor application, comprising a set of configuration commands for execution by network switch 104. The user causes computer system 102 to transmit new configuration file 128 to network switch 104 via switch connection 106. In at least some embodiments, receipt of new configuration file 128 by network switch 104 causes the network switch to perform a sequence of functions and execute one or more commands to modify the configuration of the network switch based on the new configuration file 128 received from user system 102.

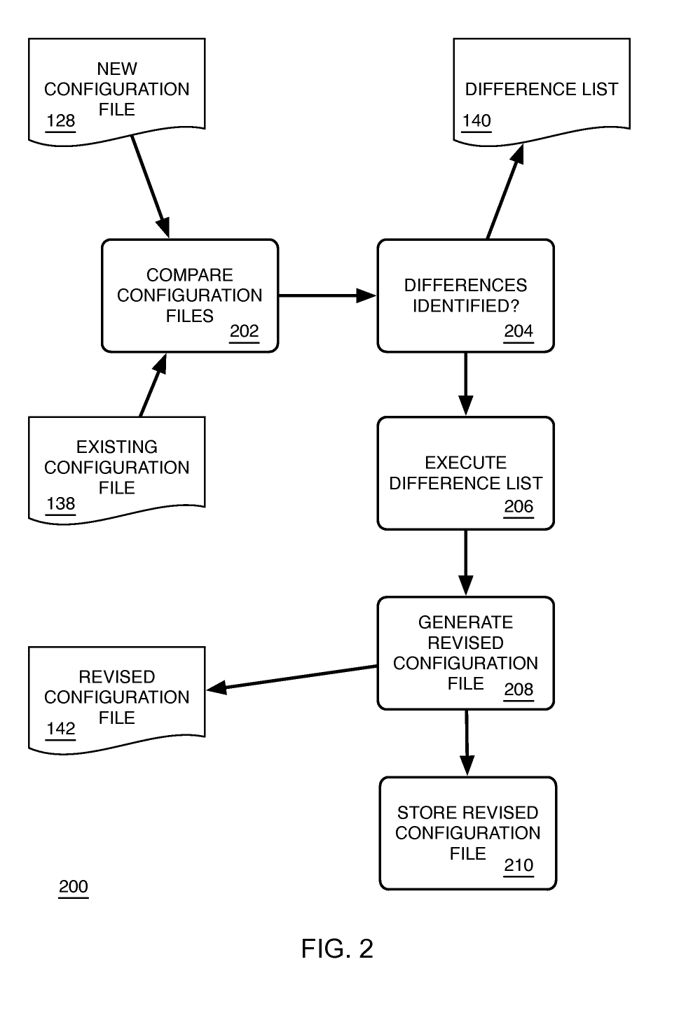

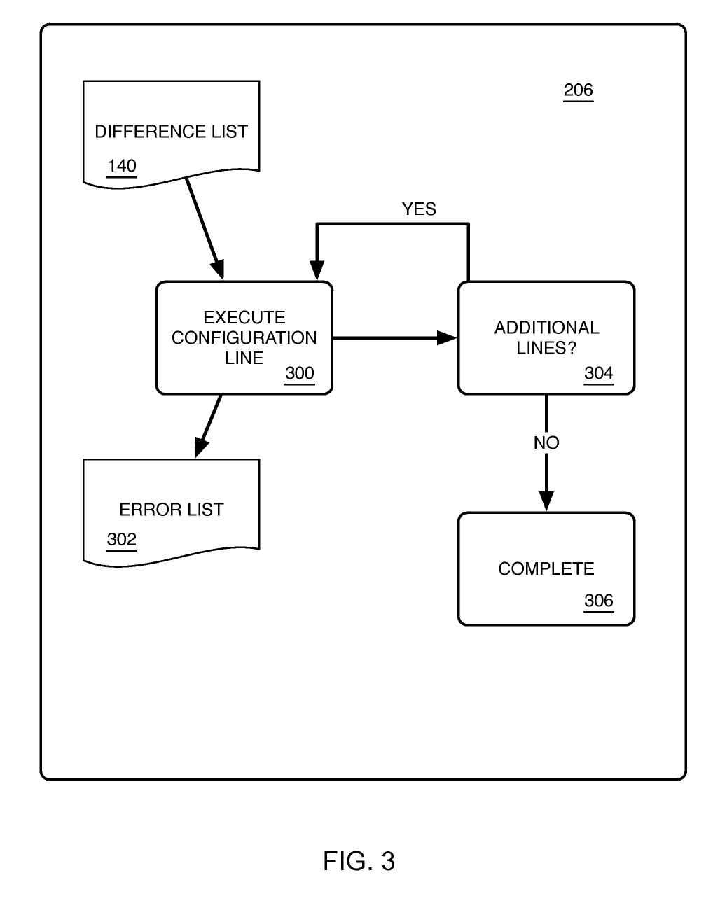

In one or more other embodiments, a user of computer system 102 communicates with network switch 104 via switch connection 106 to interact with an editor, i.e., a set of executable instructions on the network switch which when executed enable user editing of configuration files. In accordance with the particular embodiment, user interaction with the editor executing on network switch 104 enables the user to create and/or modify configuration files on the network switch. In some embodiments, network switch 104 performs the method described below in conjunction with FIGS. 2 and 3 after the user triggers execution via the editor, e.g., saving a configuration file and/or executing a particular command, etc.

In accordance with one or more other embodiments, the user may specify a configuration file stored in persistent memory, such as a flash drive or other static memory storage device, of network switch 104. In some other embodiments, the user may specify one or more date-ordered configuration files stored in either computer system 102 and/or network switch 104 to which the current configuration file of the network switch is to be modified to correspond. That is, the user may specify an earlier dated configuration file to which the current configuration file is to be modified. In a particular example, the user may maintain a backup copy of a known operational configuration file on network switch to which the current configuration is modified. In this manner, a misconfigured configuration file of network switch 104 may be modified to correspond to a backup configuration file which is known, by the user, to place the network switch into an operational state.

Network 100, specifically switch connection 106 and network link 110, comprises a communication connection operable for enabling communication between computer system 102, network switch 104, and additional devices 108. Network 100 may be a wired or wireless network, e.g., a fiber-optic network, a copper-based wire network, a cellular telephone network, a satellite telephone network, an analog network, a digital network, etc. The protocols used on network 100 are protocols enabling communication between computing devices, e.g., Ethernet, token ring, switched network, etc.

Network switch 104 comprises a processor 130, an optional I/O device 132 (dot-dashed line), a network interface 134, and a memory 136 communicatively coupled to each other and/or via a bus-based mechanism. Processor 130 controls operation of network switch 104 according to instructions and/or input received from one or more of I/O device 132, network interface 134, and instructions stored in memory 136.

Optional I/O device 132 transmits user-supplied commands and information to network switch 104 and/or displays information from processor 130 to a user. For example, optional I/O device 132 may comprise input devices such as a keyboard, a touch-screen display, and a mouse, etc. and the I/O device may comprise output devices such as an audio speaker, a display such as one or more lights, LCD panels, or another device capable of communicating information to the user.

Network interface 134 communicatively couples network switch 104 to computer system 102 via switch connection 106 and to devices 108 via network link 110. In at least some embodiments, network interface 134 provides for one-way and/or two-way network communication with computer system 102 and/or devices 108. Network interface 134 sends and receives electrical, electromagnetic, and/or optical signals which carry digital data streams representing various types of information. Network interface 134 may comprise wired and/or wireless links. In at least some embodiments, network switch 104 comprises a plurality of network interfaces.

Memory 136, such as a magnetic-based memory, an electronic-based memory, or an optical-based memory, is provided and coupled with network switch 104 for storing data and instructions. In at least some embodiments, memory 136 comprises an existing configuration file 138 representing the current configuration of network switch 104, new configuration file 128 received from computer system 102, a differences list 140, and a revised configuration file 142. In at least some embodiments, as described above, new configuration file 128 may be created and/or stored and/or modified in memory 136 on network switch 104. Difference list 140 represents a set of differences determined as a result of comparing new configuration file 128 and existing configuration file 138. Revised configuration file 142 represents a set of revised configuration commands resulting from the comparison of existing configuration file 138 and new configuration file 128.

FIG. 2 is a high-level process flow diagram of operation of a portion 200 of network switch 104 according to an embodiment of the present invention. In at least one embodiment, network switch 104 comprises an existing configuration file 138 and receives a new configuration file 128 from computer system 102 for causing a change of the network switch configuration. The process flow begins at functionality 202 wherein execution by processor 130 of a sequence of instructions from memory 136 causes the processor to compare the received new configuration file 128 with the existing configuration file.

In some embodiments, compare configuration files 202 functionality is executed in response to receipt of new configuration file 128 by network switch 104. In some embodiments, compare configuration files 202 functionality is executed in response to receipt of a command signal from computer system 102 received after receipt of new configuration file 128.

In some embodiments, compare configuration files 202 functionality operates on a line-by-line basis, while in other embodiments, the functionality operates on a command-by-command basis. In some embodiments, processor 130 performs a consistency check on the content of new configuration file 128 to determine whether the commands presented for execution are valid for network switch 104 and/or whether conflicting commands are present. According to this embodiment, the flow terminates and, in some further embodiments, an error message is generated indicating the determined inconsistency of new configuration file 128.

The process flow proceeds to functionality 204 wherein differences identified during the comparison functionality 202 execution cause the generation of a difference list 140. In some embodiments, functionality 202 and 204 may be performed in an iterative fashion adding identified differences to difference list 140 for each comparison performed, e.g., line-by-line, command-by-command, etc., in functionality 202. In at least some embodiments, difference list 140 comprises a set of commands which are present in new configuration file 128 and not present in existing configuration file 138, i.e., new commands not already existing in existing configuration file 138. In at least some embodiments, difference list 140 comprises a set of commands from new configuration file 128 which replace a set of commands present in existing configuration file 138, e.g., the command ‘hostname “HP ProCurve Switch 5308XL”’ may be replaced by the command ‘hostname “Joes' ProCurve Switch”’. In at least some embodiments, difference list 140 may comprise commands negating a specified configuration of existing configuration file 138 based on the absence of a corresponding set of commands in new configuration file 128, e.g., existing configuration file 138 may comprise a command causing creation of a virtual local area network (VLAN), however, the new configuration file may lack a corresponding vlan command resulting in the generation of a command to remove the created vlan such as no vlan 20. In at least some further embodiments, functionality 204 executed by processor 130 causes the generation of a set of commands to cause the reconfiguration of network switch 104 to correspond to new configuration file 128. In at least some embodiments, processor 130 executing functionality 204 attempts to generate a minimum set of commands necessary to cause the reconfiguration of network switch 104.

In at least some embodiments, processor 130 executing functionality 204 causes difference list 140 to be generated in an ordered fashion, e.g., the difference list comprises an ordered list of commands. For example, some commands depend on the execution of other commands. In a particular example, a “vlan” command causes creation of a VLAN and is executed prior to another command, e.g., an “ip address” command, which reference the created VLAN. After generation of difference list 140, the flow proceeds to functionality 206.

Processor 130 executes the commands comprising the difference list 140 thereby modifying the existing configuration of network switch 104 to the configuration specified by new configuration file 128. In this manner, network switch 104 executes a new configuration without requiring a configuration reload and/or a restart of the network switch and/or un-effected network protocols.

After execution of difference list 206, the flow proceeds to processor 130 executing instructions comprising functionality 208 for causing the generation of a revised configuration file 142. Revised configuration file 142 comprises a revised set of commands from existing configuration file 138 and new configuration file 128. The flow proceeds to functionality 210 wherein the processor executes a sequence of instructions causing network switch 104 to store the revised configuration file. In at least some embodiments, the stored revised configuration file is stored as existing configuration file 138 overwriting the previous version of the existing configuration file.

In at least some embodiments, as described above, during execution of process flow portion 200, new configuration file 128 may be created and/or stored and/or modified in memory 136 on network switch 104.

FIG. 3 depicts a detail view of a process flow diagram of operation of execute difference list functionality 206 of network switch 104 according to an embodiment of the present invention. In at least one embodiment, each line of difference list 140 comprises a command for execution by processor 130. The process flow begins at execute configuration line functionality 300 wherein processor 130 executes a configuration command from difference list 140. If execution of the command causes the generation of an error by network switch 104, processor 130 causes generation of an error on an error list 302.

The flow proceeds to determine whether additional lines are present in difference list 140 by executing additional line functionality 304. If additional lines are present (YES path) for execution in difference list 140, the flow returns to functionality 300 for execution of at least one of the additional lines. If additional lines are not present (NO path), the flow proceeds to complete functionality 306.

In some embodiments, error list 302 may be transmitted to computer system 102 for display to a user. In some embodiments, error list 302 may be stored in memory 136 of network switch 104 for access by computer system 102. In some other embodiments, error list 302 is not generated and instead any error-generating commands are not executed by processor 130 and may be removed from difference list 140. In some embodiments, during complete functionality 306, processor 130 may modify difference list 140 in view of error list 302, e.g., removing error-generating commands from the difference list. In still further embodiments, processor 130 may modify generation of revised configuration file 142 in view of error list 302.

What is claimed is:

1. A method of manipulating a configuration file for a network switch, comprising:
generating a difference list based on a comparison of an existing configuration file and a new configuration file for a network switch;
executing commands from the generated difference list to configure the network switch; and
generating a revised configuration file based on the new configuration file and the existing configuration file.

2. The method as claimed in claim 1, further comprising:
receiving a new configuration file for a network switch.

3. The method as claimed in claim 1, further comprising:
generating, at the network switch, the new configuration file.

4. The method as claimed in claim 1, further comprising:
storing the generated revised configuration file.

5. The method as claimed in claim 4, wherein the storing comprises:
replacing the existing configuration file with the revised configuration file.

6. The method as claimed in claim 1, further comprising:
storing, at the network switch, the generated revised configuration file.

7. The method as claimed in claim 1, wherein the executing commands is performed on a line-by-line basis.

8. The method as claimed in claim 1, further comprising:
generating an error list based on execution of at least one command from the generated difference list.

9. The method as claimed in claim 8, wherein the generating a revised configuration file is performed using the existing configuration file, the new configuration file, and the generated error list.

10. The method as claimed in claim 1, wherein the difference list comprises an ordered list of commands.

11. A network switch for manipulating a configuration file based on a new configuration file and an existing configuration file, comprising:
a processor;
a memory connected with the processor and storing a new configuration file, and an existing configuration file, and instructions causing the processor, after execution of the instructions by the processor, to generate a difference list based on a comparison of the existing configuration file and the new configuration file, to execute commands from the generated difference list, and to generate a revised configuration file based on the new configuration file and the existing configuration file.

12. The network switch as claimed in claim 11, further comprising instructions to cause the processor to receive a new configuration file for the network switch.

13. The network switch as claimed in claim 11, further comprising instructions to cause the processor to store the generated revised configuration file in memory.

14. The network switch as claimed in claim 13, wherein the instructions causing the processor to store the generated revised configuration file further comprise instructions causing the processor to replace the existing configuration file with the revised configuration file.

15. The network switch as claimed in claim 11, further comprising instructions to cause the processor to generate an error list based on execution of at least one command from the generated difference list.

16. The network switch as claimed in claim 11, wherein the difference list comprises an ordered list of commands.

17. A memory or a computer-readable medium storing instructions which, when executed by a processor, cause the processor to generate a difference list based on a comparison of the existing configuration file and the new configuration file, to execute commands from the generated difference list, and to generate a revised configuration file based on the new configuration file and the existing configuration file.

18. The memory of computer-readable medium as claimed in claim 17, further comprising instructions to cause the processor to receive a new configuration file.

19. The memory of computer-readable medium as claimed in claim 17, further comprising instructions to cause the processor to store the generated revised configuration file.

20. The memory of computer-readable medium as claimed in claim 19, wherein the instructions causing the processor to store the generated revised configuration file further comprise instructions causing the processor to replace the existing configuration file with the revised configuration file.

21. The memory of computer-readable medium as claimed in claim 17, further comprising instructions to cause the processor to generate an error list based on execution of at least one command from the generated difference list.

22. The memory of computer-readable medium as claimed in claim 17, wherein the difference list comprises an ordered list of commands.
